(19) United States
(12) Patent Application Publication
(10) Pub. No.: US 2006/0023387 A1
(43) Pub. Date: Feb. 2, 2006

(54) ESD device for high speed data communication system with improved bandwidth

(75) Inventors: Nader Badr, Ames, IA (US); William Black, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: Iowa State University Research Foundation, Inc., Ames, IA (US)

(21) Appl. No.: 11/182,166

(22) Filed: Jul. 14, 2005

Related U.S. Application Data
(60) Provisional application No. 60/588,286, filed on Jul. 15, 2004.

(51) Int. Cl. H02H 1/00

(52) U.S. Cl. 361/129

(57) ABSTRACT

An integrated circuit for a high speed data communication system with improved Electrostatic Discharge (ESD) protection is provided. The circuit includes first and second monolithic transformers. An ESD device connected between the first and second monolithic transformers. There are first and second on-chip spark gaps for forming low impedance grounds during ESD events. The first on-chip spark gaps are electrically connected to the first monolithic transformer and the second on-chip spark gaps are electrically connected to the second monolithic transformer.

### PRIORITY STATEMENT

This application claims priority to U.S. Provisional Patent Application No. 60/588,286, filed Jul. 15, 2004, herein incorporated by reference in its entirety.

### BACKGROUND OF THE INVENTION

The present invention relates to chip design. More particularly, but not exclusively, the present invention relates to chip design that provides ESD protection and is suitable for use in high speed data communication systems.

In recent years, much research has focused on improving high speed data communication systems especially in wireline data communication systems. The data rate can reach several Gbit/s. Several products offer around 3 Gbit/s data rate. There are several challenges that have to be met in order to increase the data rate to several Gbit/s. One of the challenges is the Electrostatic Discharge (ESD) protection devices that are placed at the driver and receiver to protect the chip from ESD events that can be devastating to the chip interior circuitry. The ESD devices, on the other hand, act as low pass filters that filter out the driver transmitted signal above a few GHz. It is very impractical to design a chip with no ESD protection because it becomes very vulnerable to ESD events resulting in lower yield and field failures.

The mechanism of ESD protection is to provide an alternate low impedance path for the current to be discharged to the substrate or ground of the chip instead of entering the internal circuitry and damaging sensitive active and passive devices.

The ESD event can be the result of a human hand touching the chip or even getting close to it. The human body can be charged up to several kilo-Volts. One source of the charge accumulation is the person walking on carpet. If the human hand touches a chip already charged at a ground potential, a potential difference will result in discharge of the charge on the human body to the chip. The electrical model for this phenomenon is called the Human Body Model (HBM). This ESD event can be damaging to the chip.

Another source of ESD event is when the chip becomes charged, and then discharges after one of its pins is connected to another potential point like ground. If it is not well-protected, the ESD event of this type is faster and more critical to the chip than HBM phenomenon. The electrical model for this event is known as the Charge Device Model (CDM).

In the normal circuit operating mode, the ESD device is off and virtually no current passes through it. The input signal bypasses the ESD device and is directed to the internal circuitry which is usually the gate of a MOSFET transistor or the base of a bipolar transistor. In principle, the ESD device should not affect the normal operation of the chip internal circuit. In reality, the ESD device does affect the electrical properties of the signal path, and careful consideration of the tradeoffs should take place to ensure the optimal performance of the chip.

In the case of an ESD event, the ESD device is activated through the voltage breakdown characteristics of the device. The ESD device bypasses the internal circuitry, and provides an alternate low impedance path for the large current to be dissipated in it. The ESD device is designed to be large enough to be capable of passing current on the order of several Amperes. However, using a large device comes at the cost of increasing parasitic capacitances at the node where the ESD protection is introduced.

If the internal circuitry of the chip does not have ESD protection devices, then its vulnerability to ESD damage is high. If an ESD current affects the chip and passes through the internal circuitry, a damage can occur to it in the form of dielectric breakdown of gate oxide. In a typical submicron CMOS process, the gate oxide material used is usually Silicon Dixoide, SiO₂, which has a dielectric strength of around 8-10 MV/cm. The thickness of SiO₂ is on the order of 40-50 Angstroms in a typical CMOS process where the minimum draw feature length is 0.18 μm. Therefore, if a voltage in excess of 3V is applied to the gate, it can be damaged. As a result, a voltage applied to the transistor gate of this magnitude should be prevented.

Another form of ESD damage is due to thermal damage of SiO₂ and metal interconnect. This happens because of the poor thermal conductivity of SiO₂. The I²R heat is generated in the path that the current takes such as a metal interconnect. Since the ESD event elapses for a short time with large current, the heat is not dissipated as quickly as needed. The temperature of the SiO₂ is raised locally to a degree that the silicon is damaged and the metal interconnect is melted. A short circuit or an open circuit can occur and in many cases the damage can be seen under the microscope as a localized burn or melting of the metal interconnect. In addition, high leakage current in the ESD device can be observed after breakdown.

The ESD protection structure should be able to meet several goals, some of which are challenging. In many cases, there is a compromise between the high protection level, circuit operation frequency, size, and silicon area in order the achieve the best ESD protection circuit for a specific chip or design. The problem of ESD protection for RF and very high speed circuits is a particularly challenging task. The challenge is in designing an ESD protection structure that is capable of at least Class 2 (2 kV-4 kV) level of protection. At the same time, it does not impede signals with high frequency content in the GHz range, and should turn on faster than the internal circuitry in order to achieve protection.

What is needed for chips is an ESD device that allows for high speed data communication while providing adequate ESD protection. Therefore, it is a primary, object, feature, or advantage of the present invention to improve upon the state of the art by providing an ESD device for high speed data communication systems with improved bandwidth.

It is a further object, feature, or advantage of the present invention to provide a chip that is capable of sending and receiving data at a rate of several Gbits/s without being impeded by parasitic capacitances.

Another object, feature, or advantage of the present invention is to provide an ESD structure capable of protecting internal circuitry of a chip from high ESD transients.

A still further, object, feature, or advantage of the present invention is to provide a chip with internal circuitry isolated from the outside world.

Another object, feature, or advantage of the present invention is to provide a low capacitance ESD structure which is minimally disruptive of differential signals.

A further object, feature, or advantage of the present invention is to provide an ESD structure for a chip that is reliable and can withstand repeated ESD events effectively.

Another object, feature, or advantage of the present invention is to provide an ESD structure which is reasonably simple to design, layout, and fabricate.

One or more of these and/or other objects, features, or advantages of the present invention will become apparent from the specification that follows.

### SUMMARY OF THE INVENTION

The present invention provides an ESD device that places a transformer at the transmitter and receiver as an interface and as an insulator between the chip internal circuitry and the PCB interconnect. The transformer differentiates the current signal that enters its primary and then generates an induced voltage at the secondary ports of the transformer. To divert the ESD event from affecting the internal circuitry, spark gap structures are placed close to the chip pads and have a pointing shape that are close to the interconnection so that a spark can be formed between the interconnect and the spark gap. In this way, a conductive path is generated when a large voltage affects the chip. This path consists of the interconnection that reaches the chip pads from outside, the chip pads, the spark, and the connection between the spark gaps and the substrate. In addition, a set of diodes is connected to the middle point between the transformers on each of the primary and the secondary sides. In the case of an ESD event, the ESD current can pass through the low impedance path provided by the diode sets.

The present invention provides for the complete isolation between the on-chip circuitry and off chip circuitry though using a chip transformer. The ESD device can be used in RF circuits in many applications such as low noise and wireless circuit design. It can, for example, be used in high speed serializer and deserializer circuits.

The present invention provides for a high speed serial link with improved ESD protection. The architecture of the driver is to include on chip RF transformers at the driver. The transformers isolate the inner circuitry from outside the chip. The transformers can be designed to have a lower cutoff frequency that is higher than the bandwidth of the ESD signal.

According to one aspect of the present invention, an integrated circuit includes first and second monolithic transformers. There is an electrostatic discharge (ESD) device connected between the first and second monolithic transformers. First and second on-chip spark gaps for forming low impedance grounds during ESD events are electrically connected to the first and second monolithic transformer, respectively. The first on-chip spark gap is electrically connected to a secondary coil of the first monolithic transformer and the second on-chip spark gap is electrically connected to a secondary coil of the second monolithic transformer. The ESD device may include a set of diodes that are connected to the middle point between the two transformers at the primary, and another set of diodes connected to the middle point between the transformers at the secondary side. Preferably, the integrated circuit is adapted to be attached to a printed circuit board (PCB) using a Chip On Board attachment method. Each of the monolithic transformers preferably includes a primary winding and a secondary winding, and a shield between the primary winding and the secondary winding, and wherein the shield is grounded. The shield need not be continuous, but can be segmented into short segments to prevent induced currents. The transformers may be planar transformers, torroidal transformers, or of other geometries.

According to another aspect of the present invention, a system for high speed data communication with improved bandwidth is provided. The system includes a substrate, a driver chip attached to the substrate, a receiver chip attached to the substrate. Each of the driver chip and the receiver chip include first and second monolithic transformers. There is an ESD device connected between the first and second monolithic transformers. In addition, first and second on-chip spark gaps are provided for forming low impedance grounds during ESD events. The first on-chip spark gaps are electrically connected to the first monolithic transformer and the second on-chip spark gaps are electrically connected to the second monolithic transformer. Each of the first and second monolithic transformers may comprise a primary winding, a secondary winding, and a shield between the primary winding and the secondary winding. The first and second monolithic transformers may be planar transformers, torroidal transformers, or transformers of other geometries. The shield need not be continuous between the primary and secondary winding and is preferably segmented into short segments to prevent induced currents.

### BRIEF DESCRIPTION OF THE DRAWINGS

FIG. 1 is a high level illustration of one embodiment of the present invention.

FIG. 2 is an illustration of one embodiment of an ESD protection scheme according to the present invention.

FIG. 3 is a diagram of one embodiment of the present invention indicating spark gaps and transformers of the present invention.

### DETAILED DESCRIPTION OF THE PREFERRED EMBODIMENT

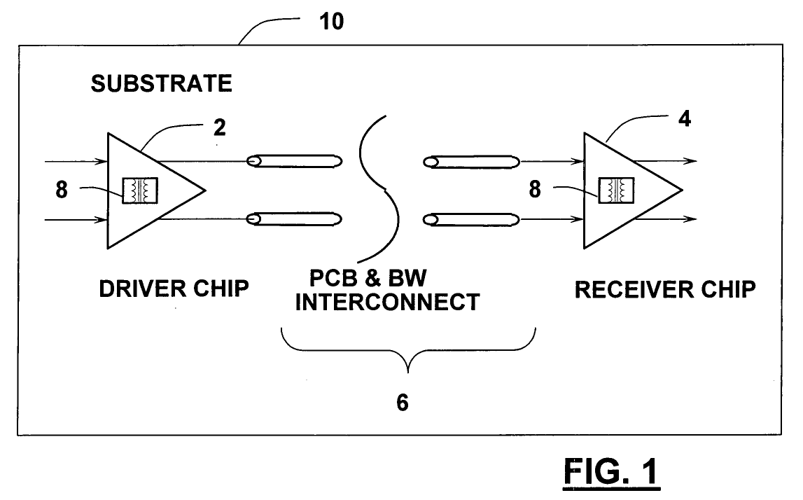

FIG. 1 illustrates a high level illustration of one embodiment of the present invention. In FIG. 1, a driver chip 2 includes a chip transformer 8 for isolating between the on-chip circuitry and the off chip circuitry. A receiver chip 4 also includes a chip transformer 8 for isolating between the on-chip circuitry and the off chip circuitry. An interconnect 6 is also shown which includes the printed circuit board (PCB) and bondwire connection between the driver chip 2 and the receiver chip 4. The driver chip 2 and receiver chip 4 are positioned on a substrate. Thus, it is shown that the present invention provides an ESD device that places a transformer at the transmitter and/or receiver as an interface and as an insulator between the chip internal circuitry and the PCB interconnect. The choice of including the ESD device at the transmitter and/or the receiver affects the encoding scheme of any signal transmitted across the ESD device. The ESD device can be used in RF circuits in many applications such as low noise and wireless circuit design. It can, for example, be used in high speed serializer and deserializer circuits.

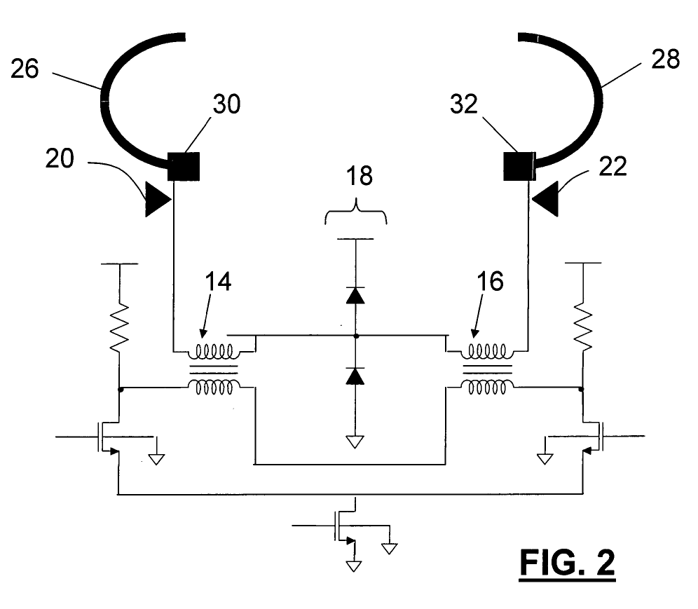

FIG. 2 illustrates one embodiment of the present invention. In FIG. 2, two identical monolithic transformers (14, 16) have ESD devices 18 connected between them. Spark gaps (20, 22) are placed close to the pads (30,32). Bond wire (26, 28) extends from the pads (30,32). The monolithic transformers (14, 16) are designed on-chip. Preferably, the monolithic transformers (14, 16) operate as transformers up to a minimum frequency of 6 GHz. The ESD device 18 is connected between the monolithic transformers (14, 16). The ESD device 18 can be a set of diodes that operate in forward bias in the case of an ESD event. The present invention contemplates that other types of ESD devices can also be used as may be appropriate under particular design considerations or constraints. For example, the ESD device may be a Silicon Controlled Rectifier (SCR) or a grounded gate MOSFET or a diode exhibiting gate-assisted breakdown. In a gate-assisted embodiment one would rely the presence of a gate at the periphery of the diode gives an enhanced breakdown characteristic. Another variation is a punch through device where two diodes or a MOSFET are used to provide for punch through of the depletion regions. These and other variations are diode-based devices in that they comprise at least one diode.

The middle point between the transformers (14, 16) is balanced and can be considered to be an AC ground. This is due to the fact that the signal transmitted is differential. The transformers (14, 16) are connected in series. The two ports of the primary are connected to the internal circuitry and the two ports of the secondary are connected to the bonding pads. The transformer layout can be planar interleaved, planar concentric, a toroidal solenoid or others.

In order to improve the bandwidth of the transformer used, the present invention provides for shielding primary and secondary windings of each transformer. This shielding allows for the coupling resonance frequency, f_{c}, to be increased. The shielding can be a thin metal layer between the primary and secondary. Preferably, the shield is not continuous between the primary and secondary, but rather segmented into short segments to prevent induced currents in it. Preferably the shield converts the coupling capacitance to self-capacitance. As the self-capacitance increases, the coupling capacitance decreases and the coupling bandwidth increases. Thus, the shield between the primary and secondary windings of the transformer may serve as a shield for a surge in voltage that is imposed on the primary of the transformer. The shield can be considered as a secondary protection measure against an ESD event.

On the secondary side, in the middle point between the transformers, an ESD device 18 is provided. The use of two diodes in the configuration shown in FIG. 2 provides for protection against both positive and negative ESD signals. The middle point between both transformers is always balanced during operation and can be considered to be an AC ground. Thus, the parasitic capacitance of the ESD device 18 in the middle does not affect the normal circuit operation, even if the ESD devices have considerably large parasitic capacitances.

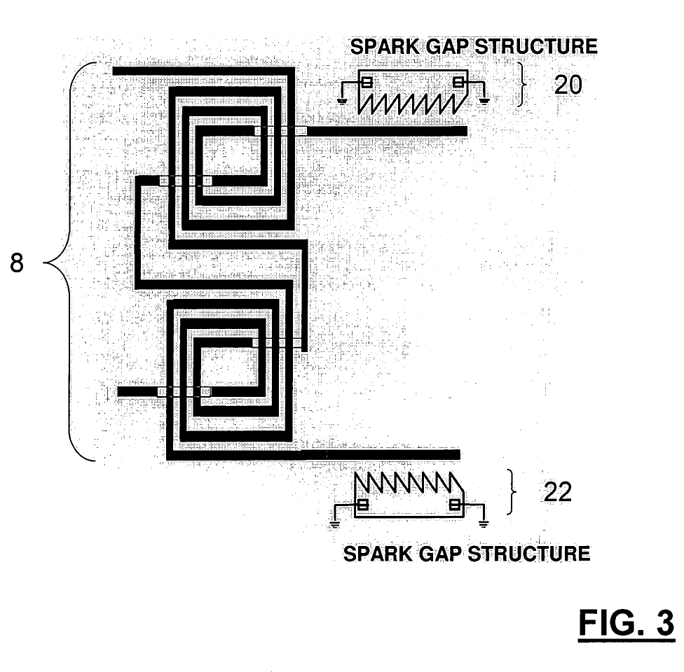

The spark gaps (20, 22) are placed close to the bonding pads on both sides of the secondary. The spark gaps (20,22) can be configured in any number of ways. In one embodiment, the spark gaps have a saw tooth shape. FIG. 3 illustrates one such embodiment of the present invention. Another variation of the spark gaps is to have the spark gap plates parallel to each other and to have them made of polysilicon material which limits the amount of current in them and makes the spark gap ignite in more than one point. The advantage of such a structure is to have a narrow gap between the anode and cathode in order to make the ignition threshold voltage smaller. The spark gaps (20, 22) are devices that can be fabricated in a standard CMOS process, and ignite and form a low impedance ground during an ESD event.

In a normal mode of operation, the transformers, ESD structure, and spark gaps act as part of the driver/receiver circuit in a wireline data communications serializer/deserializer scheme. The signals enter the transformer primary in differential current mode fashion. The four port transformer acts as an isolator.

The ESD structure can be large and yet fast enough to withstand high current and fast triggering, providing a high level of protection. The ESD protection structure can be included in a wireline data driver or receiver capable of data rates, of several Gbit/s or more as shown in FIG. 1. Another application for the ESD protection structure is in RF circuits such as the input node to a Low Noise Amplifier (LNA). The present invention is not limited to any particular type of circuit that includes the ESD protection structure of the present invention. The ESD structure of the present invention has been modeled and simulation results have shown that the ESD structure is able to protect the circuit against an HBM ESD event of up to 10 kV.

According to the present invention, it is preferred that the chip-on-board (COB), flip-chip, or other low low-inductance packaging method be used. The benefit of this type of attachment method is that it eliminates lead inductance and down bondwire. It also results in less parasitic capacitances that impede the signal path.

It should be apparent that the present invention contemplates numerous variations as may be appropriate under particular design criteria and design considerations, or to particular applications or environments. These and other variations, options, and alternatives are all within the spirit and scope of the invention which is to be limited only by the attached claims.

What is claimed is:

1. An integrated circuit comprising:
first and second monolithic transformers;
an electrostatic discharge (ESD) device connected between the first and second monolithic transformers; and
first and second on-chip spark gaps for forming low impedance grounds during ESD events, the first on-chip spark gaps electrically connected to the first monolithic transformer and the second on-chip spark gap, electrically connected to the second monolithic transformer.

2. The integrated circuit of claim 1 further comprising a pad electrically connected to and proximate each of the spark gaps.

3. The integrated circuit of claim 1 wherein the first on-chip spark gap is electrically connected to a secondary coil of the first monolithic transformer and the second on-chip spark gap is electrically connected to a secondary coil of the second monolithic transformer.

4. The integrated circuit of claim 1 wherein the ESD device comprises one or more diodes.

5. The integrated circuit of claim 1 wherein the integrated circuit is adapted to be attached to a printed circuit board (PCB) using a Chip On Board attachment method.

6. The integrated circuit of claim 1 wherein each of the first and second monolithic transformers comprises a primary winding and a secondary winding, and a shield between the primary winding and the secondary winding, and wherein the shield is grounded.

7. The integrated circuit of claim 6 wherein the shield is not continuous between the primary winding and the secondary winding, and the shield is segmented into short segments to prevent induced currents.

8. The integrated circuit of claim 1 wherein the first and second monolithic transformers are planar transformers.

9. The integrated circuit of claim 1 wherein the first and second monolithic transformers are torroidal transformers.

10. A system for high speed data communication with improved bandwidth, comprising:
a substrate;
a driver chip attached to the substrate;
a receiver chip attached to the substrate;
the driver chip and the receiver chip each comprising first and second monolithic transformers.

11. The system of claim 10 wherein each of the driver chip and receiver chip further comprise an ESD device connected between the first and second monolithic transformers.

12. The system of claim 10 wherein the driver chip and the receiver chip each further comprise first and second on-chip spark gaps for forming low impedance grounds during ESD events, the first on-chip spark gaps electrically connected to the first monolithic transformer and the second on-chip spark gaps electrically connected to the second monolithic transformer.

13. The system of claim 10 wherein each of the first and second monolithic transformers comprises a primary winding and a secondary winding, and a shield between the primary winding and the secondary winding.

14. The system of claim 13 wherein the each of the first and second monolithic transformers are planar transformers.

15. The system of claim 13 wherein each of the first and second monolithic transformers are torroidal transformers.

16. The system of claim 13 wherein the shield is not continuous between the primary winding and the secondary winding, and the shield is segmented into short segments to prevent induced currents.

17. An improvement to an integrated circuit having one or more subcircuits, the improvement comprising a driver subcircuit or a receiver subcircuit comprising first and second monolithic transformers for electrically isolating the one or more subcircuits from circuitry external to the integrated circuit.

18. The improvement to the integrated circuit of claim 17 wherein the driver subcircuit or receiver subcircuit further comprises an ESD device electrically connected between the first and second monolithic transformers.
